(19) United States
(12) Patent Application Publication
(10) Pub. No.: US 2022/0076547 A1
(43) Pub. Date: Mar. 10, 2022

(54) SYSTEMS AND METHODS FOR OPERATING EMERGENCY SYSTEMS AND EXIT SIGNS

(71) Applicant: Willard IOT, Inc., New York, NY (US)

(72) Inventors: Dean M. Willard, Honolulu, HI (US); Emily F. Willard, New York, NY (US); Warren H. Wright, Harrington Park, NJ (US)

(73) Assignee: Willard IOT, Inc.

(21) Appl. No.: 17/469,676

(22) Filed: Sep. 8, 2021

Related U.S. Application Data
(60) Provisional application No. 63/075,883, filed on Sep. 9, 2020.
(60) Provisional application No. 63/075,879, filed on Sep. 9, 2020.

(51) Int. Cl. G08B 7/06; G08B 29/18

(52) U.S. Cl. CPC G08B 7/062; G08B 29/185

(57) ABSTRACT

Systems and methods for operating an exits sign. The methods comprise: using the exit sign to denote a physical location of a closest exit of a building; obtaining, by the exit sign, sensor data generated by at least one sensor internal to or external from the exit sign, the sensor data specifying a condition or characteristic of equipment, an individual or a surrounding environment; and using the sensor data to facilitate at least one of (i) remote management of an emergency system for a building, (ii) locating of an individual or asset in the building, and (iii) management of an incident event by an organization.

### CROSS-REFERENCE TO RELATED APPLICATIONS

This application claims priority to and the benefit of U.S. Provisional Patent Application Ser. No. 63/075,883 which was filed on Sep. 9, 2020 and U.S. Provisional Patent Application Ser. No. 63/075,879 which was filed on Sep. 9, 2020. The contents of these Provisional Patent Applications are incorporated herein in their entireties.

### BACKGROUND

### Statement of the Technical Field

The present disclosure relates generally to emergency systems. More particularly, the present disclosure relates to implementing systems and methods for operating emergency systems and/or exit signs.

### Description of the Related Art

Most public locations (e.g., schools and hospitals) have exit signs located in proximity to each exitway thereof. By law, all public buildings are required to have exit signs that are in unobstructed view of one another. Exit signs are typically installed above exitways (e.g., on walls or ceilings) and/or placed at locations that provide directions to nearest points of egress.

### SUMMARY

The present disclosure concerns implementing systems and methods for operating an exit sign. The methods comprise: using the exit sign to denote a physical location of a closest exit of a building; obtaining, by the exit sign, sensor data generated by at least one sensor internal to or external from the exit sign, the sensor data specifying a condition or characteristic of equipment, an individual or a surrounding environment; and using the sensor data to facilitate at least one of (i) remote management of an emergency system for a building, (ii) locating of an individual or asset in the building, and (iii) management of an incident event by an organization.

In some scenarios, the sensor(s) include, but are not limited to, a camera, a scent detection sensor, a temperature sensor, a humidity sensor, a sound detection sensor, a light detection sensor, a proximity sensor, a motion detection sensor, a communication receiver, a LiDAR system, and/or a radar system. The sensor data may also be used to facilitate tracking of movement of the individual or asset in the building

The methods may further comprise: performing operations by the exit sign to detect when AC power is no longer being supplied by an AC power source, and activating at least one flood light of the exit sign to illuminate the surrounding environment in response to a detection that the AC power is no longer being supplied by the AC power source; performing operations by the exit sign to activate at least one flood light thereof in response to an amount of light in the surrounding environment falling below a certain value; performing a self-test by the exit sign and reporting results of the self-test to a remote device; processing the sensor data to detect an anomaly in the condition or characteristic of equipment, an individual or the surrounding environment; generating and communicating an alert from the exit sign when the anomaly is detected; and/or performing operations by the exit sign to generate and submit a work order responsive to a detection of damage to the exit sign based on the sensor data.

The anomaly may be detected when an average temperature of the surrounding environment exceeds a threshold value, when an average humidity in the surrounding environment falls below a threshold value, when an amount of light in the surrounding environment falls below a threshold value during a particular time of day, when a level of smoke in the surrounding environment exceeds a threshold value, when a particular scent exists in the surrounding environment, when a particular sound was made in the surrounding environment, when a total number of people in the surrounding area exceeds a threshold value, when an individual's movement or motion matches by a certain degree a learned pattern for detecting a health issue, and/or when an amount of time since the individual's last movement exceeds a given amount of time.

The implementing systems can comprise: a processor; and/or a non-transitory computer-readable storage medium comprising programming instructions that are configured to cause the processor to implement a method for operating an exit sign.

### BRIEF DESCRIPTION OF THE DRAWINGS

The present solution will be described with reference to the following drawing figures, in which like numerals represent like items throughout the figures.

FIG. 1 provides a perspective view of an exit sign.

FIG. 2 provides an exploded view of a sign portion of the exit sign shown in FIG. 1.

FIG. 3 provides a perspective view of another exit sign.

FIG. 4 provides an illustration showing a reader device and an exit sign.

FIG. 5 provides an illustration of a system implementing exit signs.

FIG. 6 provides a block diagram of an illustrative computing device.

FIG. 7 provides a flow chart of an illustrative method for operating an exit sign.

FIG. 8 provides an illustration that is useful for understanding light emitted from two flood lights of an exit sign.

FIG. 9 provides a flow diagram of another illustrative method for operating an exit sign.

FIG. 10 provides a block diagram of hardware components that may be used to contain or implement program instructions.

The dimensions shown in the figures are by way of example only; other sizes and shapes of various components may be used.

### DETAILED DESCRIPTION

Reference will now be made to the embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device,” computer or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, televisions, and mobile electronic devices such as smartphones, personal digital assistants, cameras, tablet computers, laptop computers, and the like. In a client-server arrangement, the client device and the server are electronic devices, in which the server contains instructions and/or data that an application of the client device accesses via one or more communications links in one or more communications networks. In a virtual machine arrangement, a server may be an electronic device, and each virtual machine or container may also be considered to be an electronic device. In the discussion below, a client device, server device, virtual machine or container may be referred to simply as a “device” for brevity.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

The term “exit sign” refers to an electronic device having an indicator that is visible to an observer to indicate a location of an exit or egress. For example, the indicator may be a word (e.g., “EXIT”), a phrase, an image, a symbol, and/or a graphic (e.g., an arrow). An exit sign may be in communication with a network system and/or electronic device(s).

Unless defined otherwise, all technical and scientific terms used in this document have the same meanings as commonly understood by one of ordinary skill in the art.

As noted above, exit signs are typically installed above exit ways (e.g., on walls or ceilings) and/or placed at locations that provide directions to nearest points of egress. Such locations are prime locations to observe or detect ambient conditions and to serve as beacons to safe egress. While current exit signs may have some integrated lights, they do not provide sufficient illumination to provide such beacons in the case of an emergency. Current exit signs also operate autonomously, without a mechanism to share diagnostic information, internal data and/or detected information with other exit signs or devices/systems. As such, operational and/or environmental conditions of one exit sign may not be known by other exit signs or devices/systems (e.g., a central monitoring device of an emergency system). This document describes implementing systems and methods that address these issues and/or which provide additional or alternative benefits associated with exits signs.

The implementing systems comprise exit signs that may be used in emergency situations. Each exit sign may (i) deliver improved illumination to critical emergency egress building locations and/or (ii) have an emergency battery backup for use when an AC main power source of a facility fails. Feature (i) can be facilitated using high output Light Emitting Diodes (LEDs) within the exit sign and/or integral LED flood light systems.

The exit signs may be part of an Internet of Things (IoT) integrated system that provides a comprehensive solution combining life safety with end-to-end building intelligence and regulatory compliance with complete IoT/cloud capabilities. In this regard, each exit sign may have sensors communicatively coupled to a processor. These devices are configured to facilitate the detection and/or identification of individuals/assets inside buildings, the monitoring of movements of the individuals/assets inside the buildings, the detection and/or tracking of locations of the individuals/assets inside the buildings, and/or the detection of changes in conditions of an environment inside the buildings (e.g., an increase of heat and/or a reduction of humidity). These operations can be based on: sensor data generated by the sensors and/or information obtained from external communication devices via Short Range Communications (SRCs) (e.g., Radio Frequency Identification (RFID) communications, WiFi, BlueTooth and/or beacon communications) and/or Long Range Communications (LRCs) (e.g., cellular communications and/or radio communications). The sensors can include, but are not limited to, cameras, scent detection sensors, temperature sensors, humidity sensors, sound detection sensors, light detection sensors (e.g., for detecting an amount of light in a hallway), motion detection sensors (e.g., beam brake sensors and/or infrared sensors), LiDAR systems, radar systems, and/or other sensors.

The sensors, processor and other electronic components are disposed in, on or through a housing of the exit sign. The housing is configured to (i) protect the internal electronic components from damage due to external forces applied to the exit sign (e.g., a ball thrown thereto, etc.) and/or (ii) inhibit the electronic components from coming in contact with harmful particles (e.g., such as water and dust). The housing can include, but is not limited to, a specification grade, aluminum extruded (clear anodized) housing with plastic end caps (high flame rated). The other electronic components can include, but are not limited to, a power source (e.g., a battery), light sources (e.g., LEDs) and/or communications devices (e.g., RFID devices, radio and/or beacon). The light source can include an energy-efficient LED illuminator array for providing an illumination of an exit indicator of the exit sign and/or an illumination of a building floor to facilitate safe emergency egress during building power outages.

The exit sign may be surface mounted or recessed mounting in a building. For example, the exit sign can be mounted on or at least partially in a ceiling (e.g., a drywall ceiling or an acoustic tile ceiling), a sidewall and/or an angled wall residing between the ceiling and sidewall.

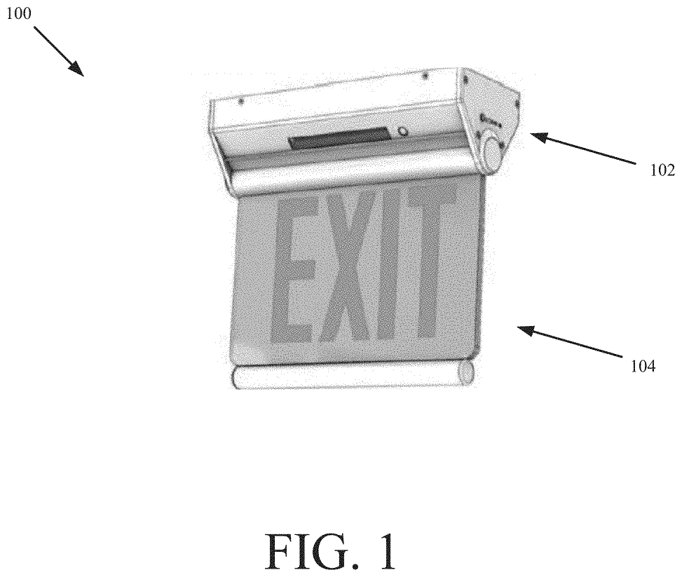

Referring now to FIG. 1, there is provided an illustration of an exit sign 100. The exit sign has many novel features. In this regard, it should be understood that the exit sign has multiple purposes in addition to being used as a way finder denoting a location of the closest emergency exit of a building in the case of fire or other emergency that requires evacuation. The other purposes include: providing a gateway for receiving, processing and sending sensor data to a cloud system; providing a waypoint for pinpointing locations of assets and/or individuals in buildings; facilitate location tracking for assets and/or individuals inside the building (e.g., via RFID technology, beacon technology and/or image processing technology); providing a supplemental emergency lighting system that qualifies as part of the life safety system required by the National Fire Protection Association; providing a back-up lighting system for the building when AC power is lost; and/or providing a power management system to extend the life of power source(s). The exit sign is also configured to perform self-tests and report results thereof to remote devices. This feature reduces the labor and cost associated with the testing of the smart exist sign, detection of operational issues with the exit sign, and/or scheduling of repair and/or maintenance of the exit sign.

As shown in FIG. 1, the exit sign 100 comprises a canopy portion 102 and a sign portion 104. The canopy portion 102 houses electronic component(s) of the exit sign. The canopy portion 102 is configured to be coupled to an external object (e.g., a wall, ceiling or other surface of a building) via coupler(s) (e.g., screw(s), latch(es), bracket(s), and/or adhesive(s)). The coupler(s) are not visible in FIG. 1.

The sign portion 104 is attached or otherwise connected to the canopy portion 102 via an attachment means (e.g., clamp(s), a spool, screw(s), latch(es), bracket(s), and/or adhesive(s)). The sign portion 104 may include an indicator 106 that is visible to an observer of the exit sign. The indicator 106 indicates a location of an exit way or egress from a building or other structure. The indicator 106 can include, but is not limited to, a word (e.g., “EXIT”), a phrase (e.g., “This Way”), a symbol (“!”), a sequence of symbols (“*!*”), an image, an icon and/or a graphic (e.g., an arrow).

The indicator 106 may be continuously, periodically and/or selectively illuminated by a light source of the exit sign. For example, the indicator 106 is illuminated when sensor data indicates that an amount of light in a surrounding environment is less than a threshold amount. In this way, the exit sign 100 can serve as a means for guiding people to an exit way or egress of a building (e.g., in emergency situations such as when a fire is present in the building and/or power to other electronic equipment of the building is discontinued (intentionally or unintentionally)).

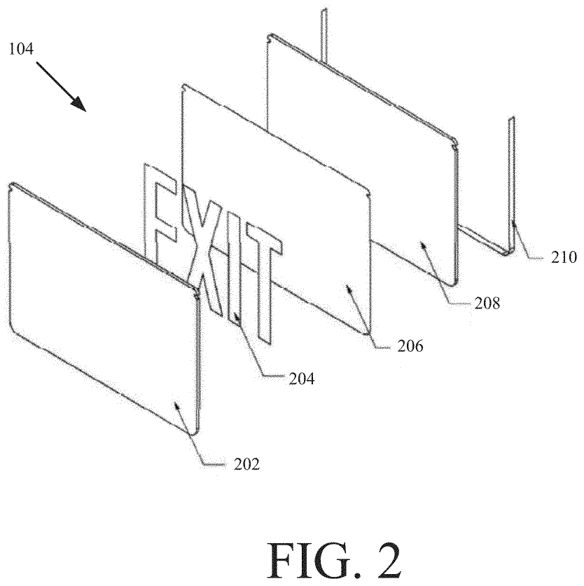

An exploded view of the sign portion 104 is provided in FIG. 2. As shown in FIG. 2, the sign portion 104 comprises a front plate 202, a sign layer 204, a reflective layer 204, a back plate 206 and an adhesive layer 208. The front plate 202 has a generally planar shape and is at least partially formed of a transparent material (e.g., a clear plastic). The front plate 202 provides protection to the sign layer 204 from damage from external objects, forces, smoke, water, dust, and/or other items. The sign layer 204 includes the indicator 106.

The reflective layer 204 may optionally be provided (i) to facilitate the reflection of light emitted from a light source internal to and/or external to the exit sign 100 in given direction(s) and/or on given object(s) (e.g., walls, a ceiling and/or a floor of a hallway), (ii) spread light evenly in a given area of a surrounding environment or on the given object(s), and/or (iii) to increase in intensity of light emitted from the light source. The reflective layer 204 can include, but is not limited to, a mylar silver film.

The back plate 206 is configured to structurally support the sign layer 204 and/or reflective layer 204. As such, back plate 206 is made from a rigid or simi-rigid material (e.g., plastic or metal). A layer of adhesive 208 is disposed on a surface of the back plate 206 to facilitate the coupling of the sign portion 104 to the canopy portion 102.

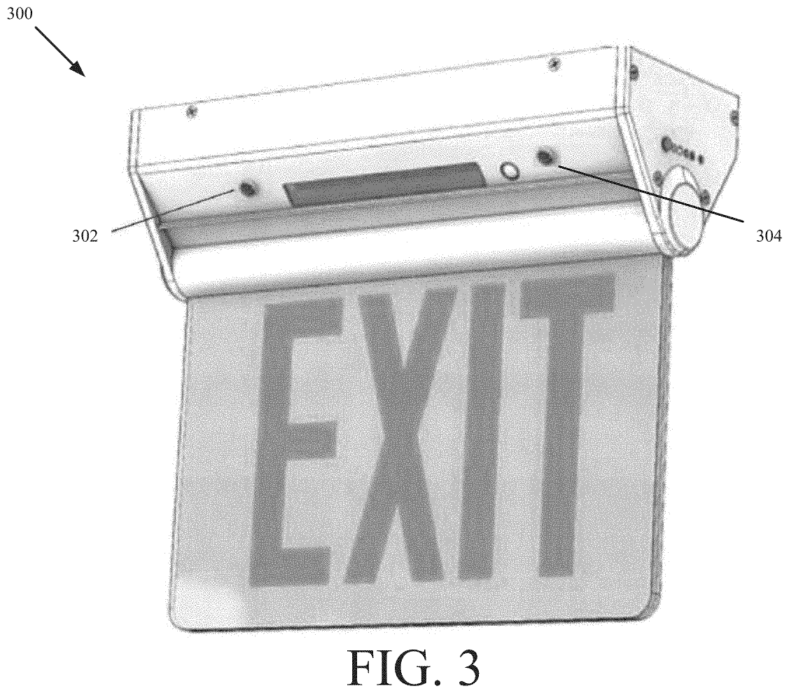

Referring now to FIG. 3, there is provided a perspective view of another exit sign 300. Exit sign 300 is similar to exit sign 100 but includes acoustic device(s) 302 and/or image capturing device(s) 304 provided therewith. The device(s) 302, 304 can be integrated with a housing of the exit sign, disposed on/in the housing of the exit sign (shown in FIG. 3), or disposed adjacent to the exit sign (not shown). In all cases, the device(s) 302, 304 are communicatively coupled to internal electronic component(s) of the exit sign via wired and/or wireless communication link(s).

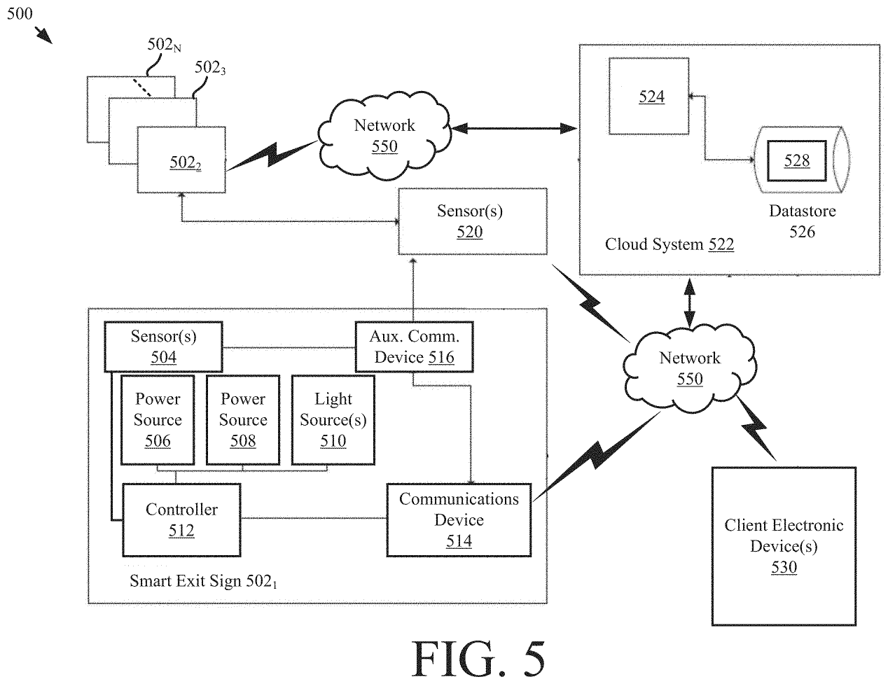

The acoustic device(s) include(s), but is(are) not limited to, power source(s), processor(s) and/or microphone(s) (e.g., a diaphragm microphone). In some scenarios, the acoustic device(s) is(are) powered by power source(s) of the smart exit sign (e.g., power source(s) 506 and/or 508 of FIG. 5). The acoustic device(s) is(are) configured to detect sound(s) and/or vibration(s) that occur in proximity to the exit sign 300. In this regard, the acoustic device(s) continuously or periodically monitor(s) ambient audio of the surrounding environment via microphone(s) and/or detect certain ambient audio (e.g., audio that exceeds a threshold decibel level). These operations of the acoustic device(s) may be additionally or alternatively be performed in response to instruction(s) from an external device.

The audio information may be communicated from the acoustic device(s) 302 to other electronic components of the exit sign (e.g., an internal controller 512 and/or communication device 514, 516 of FIG. 5). The audio information may be processed by the exit sign and/or an external device (e.g., cloud system 522 of FIG. 5). As such, the audio information may be communicated from the exit sign 300 to the external device. The processing can involve performing machine learning model(s)/algorithm(s) using the audio information to determine a likely source of the audio (e.g., a gun, a person, and alarm system). For example, a machine learning model/algorithm can be trained to detect a pattern in an audio signal which indicates that a gun was shot in the surrounding environment, a person screamed in the surrounding environment, and/or a siren/alarm was issued in the surrounding environment. The present solution is not limited to the particulars of this example. The processing can additionally or alternatively involve determining a location of an asset or person inside a building via triangulation using audio information from a plurality of exit signs.

In response to determining that the audio information is consistent with a particular source, one or more actions can be performed by the exit sign and/or the external device. For example, a notification is communicated to a remote electronic device (e.g., client electronic device 530 of FIG. 5) to notify the user thereof that a particular sound was detected in a particular area of a building. The user can include, but is not limited to, personnel of building management and/or a public safety and security organization (e.g., law enforcement, fire department and/or other emergency responders). Additionally or alternatively, the smart exit sign and/or external device can cause actuation of locks in the building for facility lockdown (with or without human assistance). The locks can include, but are not limited to, window locks and/or door locks. The present solution is not limited to the particulars of this example.

As noted above, the exit sign 300 may include image capturing device(s) 304 (e.g., a digital camera or video camera). The image capturing device(s) 304 may be powered by power source(s) of the exit sign (e.g., power source(s) 506, 508 of FIG. 5). The image capturing device is configured to capture image(s) and/or video(s) of an area surrounding the exit sign and/or another exit sign in its Line of Sight (LoS). It should be noted that the image capturing device(s) 304 is located in/on the exit sign such that the exit sign and/or other objects do not obstruct the camera's Field of View (FoV).

In some scenarios, the exit sign 300 is provided with a plurality of image capture devices. Each image capture device is positioned in/on the exit sign such that its FoV is at least partially different from the FoV of the other image capture devices provided with the exit sign. For example, a first image capturing device is positioned to capture images/videos of an area in front of the exit sign, while a second image capturing device is positioned to capture images/videos of an area behind or to a side of the exit sign. The present solution is not limited to the particulars of this example.

The FoV of each image capturing device 304 can be fixed or adjustable. In the latter case, the FOV can be adjusted manually or remotely through rotation or other movement of the image capturing device 304. The remote control of the FoV(s) can be achieved via control signals generated by and/or communicated from external device(s) (e.g., client electronic device(s) 530 and/or computing device 524 of cloud system 522 shown in FIG. 5) to the exit sign 300.

During operation, the image capturing device(s) 304 may continuously or periodically (e.g., every 15 minutes) capture images/videos of the surrounding environment. In the periodic scenarios, the amount of time between image/video captures is selected to ensure that a detection of any obstruction to the exit sign, another exit sign or building exit way is detected in an amount of time that is sufficient to address an incident event. These operations of the image capturing device(s) may be additionally or alternatively be performed in response to instruction(s) from an external device and/or in response to a detection of motion by a motion sensor of the exit sign.

The images/videos may be communicated from the image capturing device(s) 304 to other electronic components of the exit sign (e.g., an internal controller 512 and/or communication device 514, 516 of FIG. 5). The images/videos may be processed by the exit sign and/or an external device (e.g., cloud system 522 of FIG. 5). As such, the images/videos may be communicated from the exit sign 300 to the external device. The processing can involve performing machine learning model(s)/algorithm(s) using the images/videos to determine whether any anomalies exist. The anomalies can include, but are not limited to, damage to an exit sign, an operational failure of an exit sign (e.g., failure of an exit sign to illuminate), indicator lights that deviate from normal, and/or an obstruction of an exit sign. These determinations can be achieved by performance of digital image processing technique(s) to (i) extract information pertaining to an exit sign that is shown in image(s)/video(s) and (ii) compare the extracted information against a library of historical images/video(s) of the exit sign to identify and/or classify any differences therebetween.

In response to determining that an anomaly exists, one or more actions may be taken by the exit sign or another device (e.g., computing device 524 of cloud system 522 of FIG. 5). The actions can include, but are not limited to: sending a notification to external device(s) to notify user(s) thereof that an anomaly has been detected; generating/submitting a work order to have maintenance performed on the exit sign and/or other equipment (e.g., a Heating, Ventilation, and Air Conditioning (HVAC) system); generating/submitting a work order to have the exit sign and/or other equipment (e.g., a Heating, Ventilation, and Air Conditioning (HVAC) system) repaired/replaced; causing the exit sign and/or an adjacent exit sign to perform a self-test; obtaining certain information from the exit sign and/or adjacent exit sign (e.g., an operational report); triggering an emergency protocol (e.g., notifying a public safety and security organization); causing issuance of an alarm (e.g., by a first alarm system); and/or causing lighting of an emergency lighting system to be turned on). The external device(s) can include client electronic device(s) and/or computing devices of a cloud system.

The exit sign(s) may be self-monitoring and/or self-reporting. They may automatically perform performance scans, tests and/or the like. For example, an exit sign may perform a performance scan of one or more of its system components on a regular basis (e.g., weekly). Additional and/or alternate timeframes may be used within the scope of this disclosure.

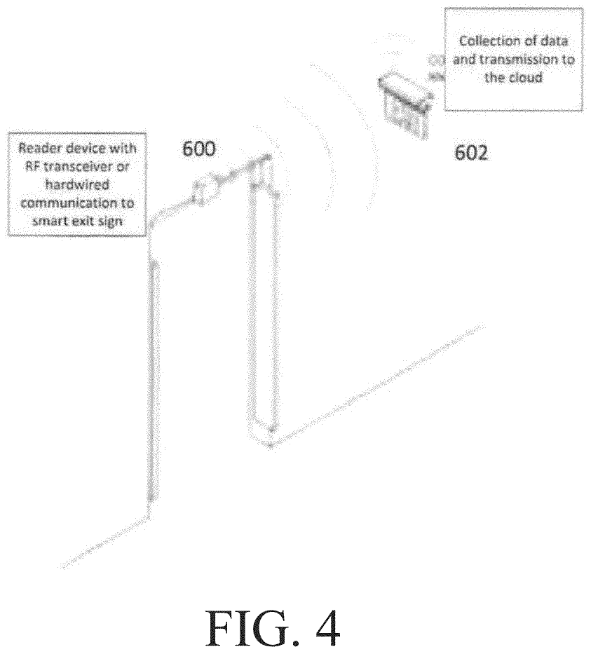

Referring now to FIG. 4, there is provided an illustration of an exit sign 602 in communication with a reader device 600. The reader device 600 may be positioned in proximity to the exit sign 602 (e.g., above a door associated with the exit sign) or remote from the exit sign 602 (e.g., in a stairwell, a hallway, a room, an elevator, etc.). The reader device 600 is configured to detect and read readable data storage devices when such devices are within range thereof. An example of a readable data storage device is a radio frequency identification (RFID) tag, and an example of a reader device is an RFID reader. As another example, a reader device and/or a readable storage device may be Bluetooth enabled and may communicate using a Bluetooth protocol. In this regard, the reader device 600 comprises transceivers for communicating with the exit sign 602, a readable data storage device and/or other devices.

The readable data storage devices may be implemented as tags, labels, stickers, fobs and/or the like. By attaching a readable storage device to an item, the movement or location of the item may be tracked based on its interactions with one or more reader devices. For example, in a hospital, a data storage device may be attached to medical equipment or supplies. The readable data storage device may store information unique to an item such as model number or other unique identifier. This information may be read by the reader device 600 when the readable data storage device is within range thereof. The readable storage device may include antenna(s) and/or other hardware for receiving and/or sending information.

In some scenarios, the readable storage device may be used to track the movement or location of individuals within an environment. For example, the readable storage device may be attached to an item carried by personnel (e.g., a security card or fob) in an environment. The readable data storage device may store information unique to an individual such as employee ID or other unique identifier.

In those or other scenarios, the reader device 600 generates and transmits a signal via a transmitter. When a readable storage device is within range of the reader device's signal, it may be powered by the signal and send information stored thereon (e.g., a unique identifier associated with the item or individual) to the reader device. The reader device may send the received information to the exit sign via a wired or wireless communication link.

The information may be passed from the reader device and/or exit sign to another device (e.g., a computing device of a cloud system) for storage (e.g., along with a timestamp) and/or processing. A user may search the timestamped information to see when an item was in what location. The another device may generate alert(s) or notification(s) when certain information is received. For example, a cloud system may send a notification when a readable storage device associated with a particular item (e.g., one that is reported missing) is or is not detected in a given period of time. The present solution is not limited to the particulars of this example.

Referring now to FIG. 5, there is provided an illustration of a system 500 implementing the present solution. System 500 comprises exit signs 502₁, 502₂, 502₃, . . . , 502_{N}. Each of the exit signs 502₁, 502₂, 502₃, . . . , 502_{N} can be the same as or similar to exit sign 100 discussed above in relation to FIGS. 1-2, exit sign 300 of FIG. 3 and/or exit sign 400 of FIG. 4.

Each exit sign 502₁, 502₂, 502₃, . . . , 502_{N} comprises a plurality of electronic components to facilitate various operations. The electronic components include, but are not limited to, sensor(s) 504, power source(s) 506, 508, light source(s) 510, a controller 512, and communication device(s) 514, 516. Sensors 504 can communicate with external sensors 520 via auxiliary communication device 516. Auxiliary communication device 516 can facilitate wired communications and/or wireless communications between sensors 504, 520. The internal and/or external sensor(s) 504, 520 may include, but are not limited to, camera(s) (e.g., digital image and/or video), temperature sensor(s), humidity sensor(s), smoke detection sensor(s), proximity sensor(s) e.g., beam brake sensors), motion sensor(s) (e.g., infrared sensors), scent detection sensors, light detection sensors (e.g., for detecting an amount of light in a hallway), LiDAR systems, radar systems, and/or other sensors. The external sensor(s) may be located in proximity to or remote from the exit sign(s).

The sensor(s) 504 may be disposed on or in a housing of the exit sign. For example, a first motion sensor is disposed on a front face of the exit sign and a second motion sensor is disposed on a rear face of the exit sign. The first and second motion sensors detect movement in a surrounding environment. The first and second motion sensors may comprise Passive Infrared (PIR) sensors that detect motion based on measured infrared light radiating from objects in its FoV, and/or sensors that detect motion based on measured sonic information generated from objects in its FOV view. Sensor data generated by the motion sensors can be processed by the exit sign or another device to detect a presence of an individual in the surrounding environment, to track movement of the individual through the surrounding environment, and/or to estimate the occupancy of a particular area. The present solution is not limited to the particulars of this example.

The temperature sensor(s) can be provided for measuring and monitoring the internal temperature of the exit signs and/or the temperature of the surrounding environments of the exit signs. This monitoring can facilitate: the detection and/or prevention conditions (e.g., overheating) that could cause damage to the internal electronic components of the exit signs; the detection of malfunctioning components of the exit signs; and/or the detection of a higher than usual temperature in the area surrounding the exit signs. The temperature measurements can be processed and/or stored at the exit sign(s) and/or external devices 530, 524, 526.

A first power source 506 may be an Alternating Current (AC) power source. The AC power source can be designed to receive power from AC mains and/or provide output voltages between, for example, 120 Volts to 277 Volts. A second power source 508 may comprise a reachargable battery and/or an energy harvesting circuit (e.g., including a circuit to harvest energy from an external environment and a super capacitor to store the harvested energy). The first power source 506 may be a primary power source for the exit sign, and the second power source 508 may be a secondary (or backup) power source for the exit sign.

In some scenarios, the battery comprises a battery which has a four-hour capacity rather than a ninety-minute capacity. The battery includes, but is not limited to, a nickel metal (cadmium) hydride battery. The battery allows the exit sign to have at least twenty years of operation without battery replacement. Batteries of conventional exit signs only allow for approximately three to four years of operation without battery replacement. The battery employed here can be disposed in a regular landfill while batteries of conventional exit signs are required to be disposed in hazardous waste facilities.

In those or other scenarios, the second power source 508 may harvest energy from, for example, light emitted from external sources and/or RF communications. In this regard, the reflective layer (e.g., reflective layer 204 of FIG. 2) of the exit sign may be configured to direct light incident thereon to a light sensor of the energy harvesting circuit to optimize energy harvesting operations. The harvested energy is converted to a Direct Current (DC) voltage.

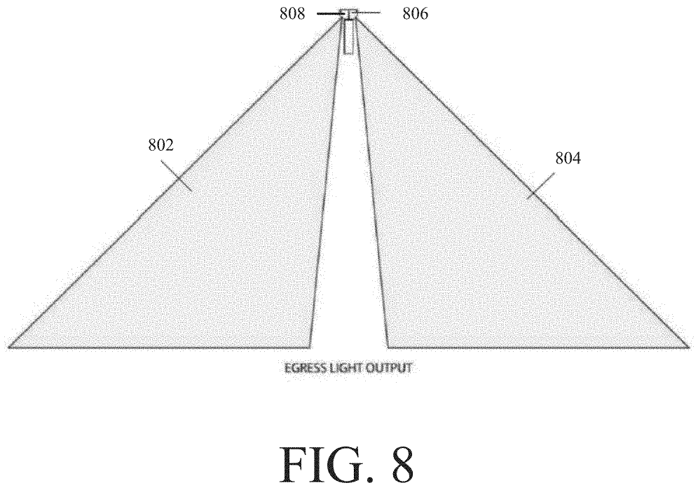

The light source(s) 510 can include, but is(are) not limited to, LEDs and/or flood light(s). The light source(s) 510 can illuminate the indicator (e.g., indicator 106 of FIG. 1) of an exit sign and/or an area surrounding or proximate to the exit sign. For instance, the light source(s) 510 comprise(s) flood light(s) angled downward to illuminate the ground. The flood light(s) can be turned on or otherwise activated in response to the exit sign losing AC power. The flood light(s) can be powered by the secondary power source 508. Illustrative light beams 802, 804 output by two flood lights 806, 808 of an exit sign is provided in FIG. 8. The present solution is not limited in this regard.

The indicator light(s) 510 may be located on the canopy portion of the exit sign 500. Two or more of the indicator light(s) 510 may have different colors. The illumination of the indicator light(s) 510 may represent different operational information pertaining to the exit sign. For example, the exit sign may include a green indicator light, a yellow indicator light, a blue indicator light and a red indicator light. Constant illumination of the green indicator light may represent that AC power is present. Constant illumination of the yellow indicator light may indicate an LED failure. Constant illumination of the red indicator light may indicate a battery failure. Blinking of the blue indicator light may indicate that the exit sign is searching for a wireless connection. The present solution is not limited in this regard. Additional and/or alternate lights and/or illuminations may be used within the scope of this disclosure.

The controller 512 is configured to control operations of the sensor(s) 504, power source(s) 506, 508, light source(s) 510, and/or communication device(s) 514, 516. The controller 512 can include, but is not limited to, processor(s) and/or data store(s) (e.g., registers). The data store(s) can store report bit(s), command bit(s), instruction(s) to cause the processor(s) to perform the control operations discussed herein. The report bit(s) may indicate the presence (or lack thereof) of an AC power input to and/or output from power source 506, the status of the light source(s) 510, a charge level of power source 508, a status of energy harvesting and/or charging operations of power source 508, sensor output(s) and/or the like. The command bit(s) may cause the exit sign to transition operations modes (e.g., from a test mode, a power save mode, a fully operational mode, etc.). One or more of the report bits and/or the command bits may be communicated to and from external devices/systems via communication device(s) 514, 516. The external devices can include, but are not limited to, sensor(s) 520, and/or a cloud system 522, and/or client electronic device(s) 530.

Communication device(s) 514, 516 can be configured to facilitate wired communications and/or wireless communications between the exit sign and an external device/system. The wireless communications can include, but are not limited to, SRCs (e.g., WiFi, BlueTooth, RFID) and LRCs (e.g., RF, cellular, Intranet communications, Internet communications, and/or LAN based communications).

The exit sign 500 may be in communication with a cloud system 522 via a network 550. The network can include, but is not limited to, a Local Area Network (LAN), a Wide Area Network (WAN), a mobile or cellular communication network, a radio network, a beacon network, an extranet, an Intranet, and/or the Internet. The term “cloud system” refers to one or more physical and/or logical devices that operate as a shared resource for multiple remote electronic devices, exit signs and/or the like.

The cloud system 522 may include host electronic device(s) and data store(s). A cloud server is an example of a host electronic device, although it is understood that additional and/or alternate types of electronic devices may be used within the scope of this disclosure. The cloud system 522 is in communication with client electronic device(s) 530 via the network(s). The client electronic device(s) 530 include, but are not limited to, smartphone(s), tablet(s), Personal Digital Assistants (PDAs), and/or portable personal computer(s). The client electronic device(s) 530 may have application(s) installed there that facilitate communications with the cloud system 522, access to resource(s) provided by the cloud system 522, and/or use of online service(s) provided by the cloud system 522.

During operation, a user of a client electronic device 530 can access and/or receive information 528 from a datastore 526 of the cloud system 522. The information 528 may pertain to the exit sign(s) 502₁, 502₂, . . . , 502_{N}. For instance, a building of an organization (e.g., a school or business entity) has the exit signs installed therein. A facilities manager of the building may have a portable device with (i) an application installed thereon to receive notifications from a computing device 524 of the cloud system 522 and/or (ii) an ability to access to a website that allows him(her) to access and view such notifications. The notification can indicate operational statuses of the exit signs (e.g., in real time or near real time), sensor data generated by sensors 504, 520, and/or reports generated by a computing device 524 of the cloud system 522 based on the sensor data. Communications between client electronic device(s), sensor(s) and/or the cloud system 522 may be performed through firewall(s).

The computing device 524 of the cloud system 522 may generate analytics based on some or all the sensor data received from the exit sign(s). The analytics can be performed to determine whether one or more anomalies exits and/or determine whether one or more events/conditions/actions have occurred. For example, the computing device 524 can analyze temperature data to determine whether a temperature of a given exit sign is outside of a normal/expected/required temperature range, and/or determine whether the temperature of an environment surrounding the given exit sign is outside of a normal/expected/required temperature range. A temperature below a normal temperature range for an area may indicate that the area is not being heated properly. A temperature above a normal temperature range for an area may indicate that an area is not being cooled properly. A temperature far exceeding a normal temperature range may indicate a fire. The present solution is not limited in this regard.

The computing device 524 can implement machine learning model(s) and/or algorithm(s). The machine learning model(s) implement the machine algorithm(s) configured to process and/or make determination(s) based on information received from the exit sign(s). For example, a machine learning model may implement neural network(s) that process sensor data in order to recognize patterns therein and/or to recognize patterns in a combination of the sensor data and other information. The machine learning algorithm(s) can include, but is not limited to, a supervised learning algorithm, an unsupervised learning algorithm, and/or a semi-supervised algorithm. Each of the listed machine learning algorithms are well known in the art, and therefore will not be described herein. Any known or to be known machine learning algorithm can be used herein without limitation.

The machine learning algorithm(s) can be trained with the information received from the smart sign(s) and/or feedback from user(s) of system 500. For example, if the data indicates a variation of a past case, it may be used to retrain one or more machine learning model(s)/algorithm(s) to handle a new variation of that case. If the data specifies new information that the system has not encountered before, then it may be used to develop new image analytics and train the machine learning model(s)/algorithm(s) on sample sets to produce higher accuracy.

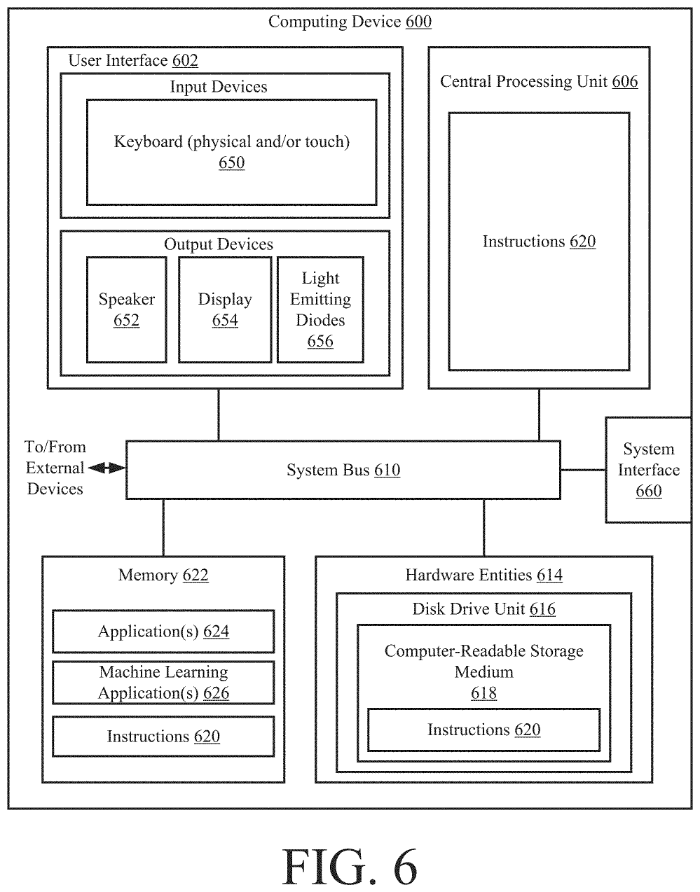

Referring now to FIG. 6, there is provided a block diagram of an illustrative computing device 600. Controller 512, computing device 524, and/or client electronic device(s) 530 of FIG. 5 can be the same as or similar to computing device 600. As such, the following discussion of computing device 600 is sufficient for understanding controller 512, computing device 524, and/or client electronic device(s) 530 of FIG. 5.

Computing device 600 may include more or less components than those shown in FIG. 6. However, the components shown are sufficient to disclose an illustrative embodiment implementing the present solution. The hardware architecture of FIG. 6 represents one embodiment of a representative computing device configured to facilitate improved smart sign operation, smart sign control and/or building emergency system management. As such, the computing device 600 of FIG. 6 implements at least a portion of a method for operating emergency systems and/or exit signs in accordance with the present solution.

Some or all the components of the computing device 600 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 6, the computing device 600 comprises a user interface 602, a Central Processing Unit (CPU) 606, a system bus 610, a memory 612 connected to and accessible by other portions of computing device 600 through system bus 610, and hardware entities 614 connected to system bus 610. The user interface can include input devices (e.g., a keypad 650 and/or a camera 658) and output devices (e.g., a speaker 652, a display 654, and/or LEDs 656), which facilitate user-software interactions for controlling operations of the electronic device 600.

At least some of the hardware entities 614 perform actions involving access to and use of memory 612, which can be a RAM, a disk driver and/or a Compact Disc Read Only Memory (CD-ROM). Hardware entities 614 can include a disk drive unit 616 comprising a computer-readable storage medium 618 on which is stored one or more sets of instructions 620 (e.g., software code) configured to implement one or more of the methodologies, procedures, or functions described herein. The instructions 620 can also reside, completely or at least partially, within the memory 612 and/or within the CPU 606 during execution thereof by the computing device 600. The memory 612 and the CPU 606 also can constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding or carrying a set of instructions 620 for execution by the computing device 600 and that cause the computing device 600 to perform any one or more of the methodologies of the present disclosure.

In some scenarios, the hardware entities 614 include an electronic circuit (e.g., a processor) programmed for facilitating the control and operation of emergency systems and/or exit signs. In this regard, it should be understood that the electronic circuit can access and run application(s) 624 and/or a machine learning application(s) 626 installed on the computing device 600. The applications 624, 626 are configured to be compatible with conventional building management systems (e.g., IBM Maximo building management systems), cloud platforms and/or open shift software.

The machine learning application(s) 626 implements Artificial Intelligence (AI) that provides the computing device 600 with the ability to automatically learn and improve data analytics from experience without being explicitly programmed. The machine learning application(s) employ(s) one or more machine learning algorithms that learn various information from accessed data (e.g., via pattern recognition and prediction making). Machine learning algorithms are well known in the art, and therefore will not be described herein in detail. Any known or to be known machine learning algorithm can be used herein without limitation. For example, in some scenarios, the machine learning application 626 employs a supervised learning algorithm, an unsupervised learning algorithm, and/or a semi-supervised algorithm. The learning algorithm(s) is(are) used to model emergency system and/or exit sign decisions based on data analysis (e.g., captured images/videos, temperature measurements, humidity measurements, range or distance determinations(s), scent detections, smoke detections, human motion/movement detection(s), client device identifier(s), fault detections, error detections, AC power discontinuation, and other information).

The machine learning algorithm(s) may be configured to detect patterns in data indicating that a system fault is likely to occur; system maintenance is likely required; a component failure of an exit sign is likely to occur; and/or an anomaly exists. The anomaly can exits, for example, when an average temperature of a surrounding environment of an exit sign exceeds a threshold value, when an average humidity in the surrounding environment falls below a threshold value, when an amount of light in the surrounding environment falls below a threshold value during particular times (e.g., during business hours or other times of day when light is expected to be present), when a level of smoke in the surrounding environment exceeds a threshold value, when a particular scent (e.g., fuel or burning rubber or electrical wires) was detected in the surrounding environment, when a particular sound was detected in the surrounding environment, when a total number of people in the surrounding area exceeds a threshold value (e.g., indicating that there may be an emergency situation in which people needs to exit the building via stairs rather than elevators), when an individual's movement or motion matches (by a certain degree) a learned pattern for detecting a health issue (e.g., a heart attack or a seizure), and/or when an amount of time since the individual's last movement exceeds a given amount of time (e.g., indicating unconsciousness). The present solution is not limited to the particulars of this example.

The software applications 624, 626 are generally operative to: obtain information from exit signs and/or client electronic devices; store the information in a datastore (e.g., memory 612 of FIG. 6 or datastore 526 of FIG. 5) so as to be associated with the respective exit signs and/or client electronic devices; process the information to detect possible tampering of the exit sign(s); generate output(s) (e.g., an alert or notification) indicating that possible tampering of the exit sign(s) has(have) been detected at given location(s) in a building; use information from the exit signs and/or client electronic devices for machine learning purposes; use machine learning to learn and understand different states and/or conditions of the exit sign(s), sensor(s) (e.g., sensors 520 of FIG. 5), and/or area(s) in buildings (e.g., a normal condition/state, a faut condition/state, a security threat condition/state, an emergency condition/state, and/or a possible tampering condition/state); use machine learning to learn and understand different states and/or conditions of equipment inside a building (e.g., properly located, misplaced, undamaged and/or damaged); generate alerts and/or notifications when certain conditions/states of the equipment are detected (e.g., the alert/notification comprising an indication of the quantity of an item needs maintenance, or an indication of a location of a misplaced item); prioritize the alerts and/or notifications based on certain criteria (e.g., level of security threat or emergency situation); cause the exit sign(s) to transition operational state(s) when certain criteria exists (e.g., security threat or emergency situation); use machine learning to learn movement patterns and/or schedules of individual(s); process sensor data to detect and track movement of individual(s) inside building(s); process sensor data to detect any anomalies in the movement of the individual(s) inside the building(s); issue alerts or notifications when such anomalies are detected; process the sensor data to detect health issues of individual(s) inside the building(s); and/or issue alerts or notifications when certain health issues (e.g., a heart attack or seizure) are detected. Other functions of the software applications 624, 626 will become apparent as the discussion progresses.

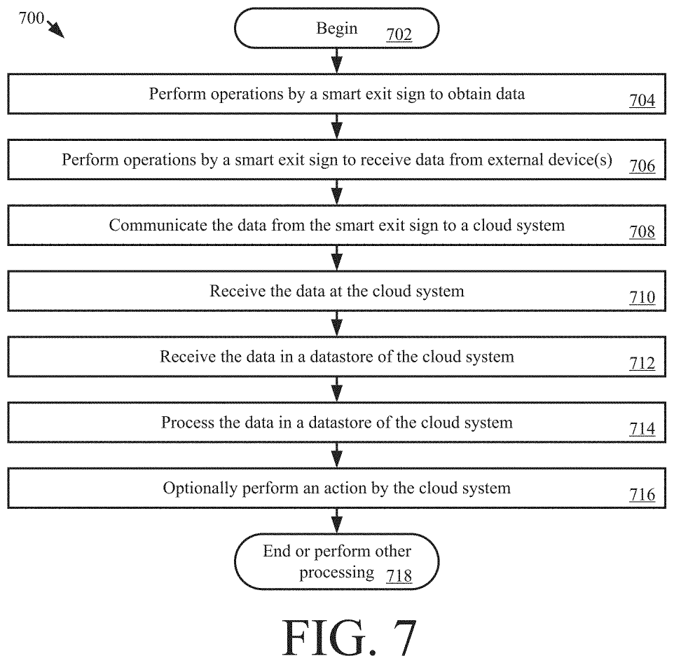

Referring now to FIG. 7, there is provided a flow diagram of an illustrative method 500 for operating a system (e.g., system 500 of FIG. 5) employing exit sign(s) (e.g., exit sign 100 of FIG. 1, 300 of FIG. 3, 400 of FIG. 4, 502₁, . . . , and/or 502_{N} of FIG. 5). Method 700 begins with 702 and continues with 704 where the exit sign(s) perform(s) operations to obtain data. The data may specify operational status(es) of component(s) of the exit sign(s), possible tampering of the exit sign(s), condition(s) of an environment surrounding the exit sign(s), detection(s) of individual(s) within building(s), health status(es) of the individual(s), and/or location(s) of equipment within building(s). The data can be obtained by detecting information, measuring information, capturing information and/or the like. The data can be obtained continuously, periodically and/or in response to receiving instructions or trigger events (e.g., detection of smoke or motion/movement in proximity thereto which causes certain sensor data to be generated). The data can comprise sensor data generated by internal sensor(s) of the exit sign(s) and/or external sensor(s) of the exit sign(s). Accordingly, the exit sign(s) can receive data from external device(s), as shown by 706.

In 708, the exit sign(s) communicates some or all the data to a cloud system (e.g., cloud system 522 of FIG. 5). This communication can be achieved via wired and/or wireless communications via a network (e.g., network 550 of FIG. 5). The cloud system received the data in 710. At the cloud system, the data is stored in a datastore (e.g., datastore 526 of FIG. 5). The data may include timestamp information that is also stored in the datastore to create a traceable and auditable data log of measured, sensed or detected information or events.

In 714, the cloud system processes the data. The data can be processed to detect whether one or more anomalies exist. An anomaly refers to a condition, event, occurrence, or operational status that deviates from the standard, normal or what is expected. An anomaly can be detected using machine learning algorithm(s) to detect patterns in the data which indicate a learn condition defining an anomaly, pre-defined rule(s), and/or comparison operations using threshold value(s). An anomaly can be detected, for example, when an average temperature of a surrounding environment of an exit sign exceeds a threshold value, when an average humidity in the surrounding environment falls below a threshold value, when an amount of light in the surrounding environment falls below a threshold value during particular times (e.g., during business hours or other times of day when light is expected to be present), when a level of smoke in the surrounding environment exceeds a threshold value, when a particular scent (e.g., fuel or burning rubber or electrical wires) was detected in the surrounding environment, when a particular sound was detected in the surrounding environment, when a total number of people in the surrounding area exceeds a threshold value (e.g., indicating that there may be an emergency situation in which people needs to exit the building via stairs rather than elevators), when an individual's movement or motion matches (by a certain degree) a learned pattern for detecting a health issue (e.g., a heart attack or a seizure), and/or when an amount of time since the individual's last movement exceeds a given amount of time (e.g., indicating unconsciousness).

In 716, the cloud system can optionally perform a given action when an anomaly is detected. For example, the cloud system can: generate and communicate an alert to a client electronic device (e.g., client electronic device 530 of FIG. 5) when an anomaly is detected (e.g., when an average temperature measured by a temperature sensor of an exit sign is equal to or exceeds a threshold value, or when smoke or a particular scent has been detected by a sensor of the exit sign); automatically generate and submit a work order when damage or tampering to the exit sign is detected; generate and send notification(s)/alert(s) to client electronic device(s) notifying individual(s) when a low battery condition of an exit sign is detected; and/or cause flood light(s) (e.g., flood lights 702, 704 of FIG. 7) of exit sign(s) to turn on when AC power to the building is discontinued. The alert/notification can include, but is not limited to, an email, a text message, a pop-up window, a voice message, a noise (e.g., one or more beeps output from a client electronic device), and/or a tactile message (e.g., a vibration of a client electronic device). Subsequently, 718 is performed where method 700 ends or other operations are performed.

The foregoing method descriptions and the interface configuration are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based in the description here.

When implemented in software, the functions may be stored as one or more instructions or codes on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include CD, laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

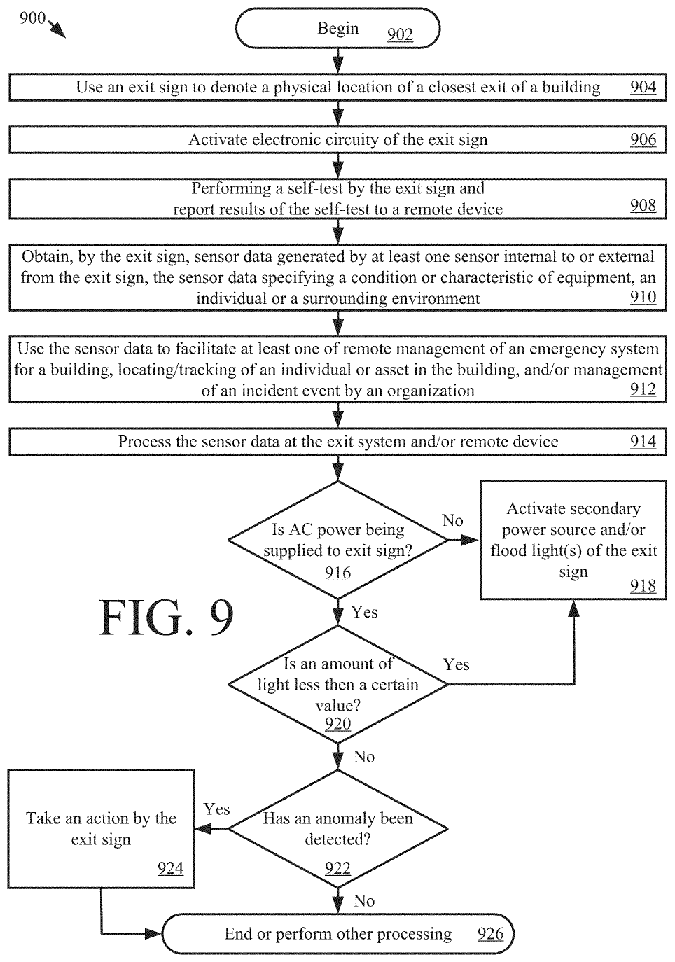

Referring now to FIG. 9, there is provided a flow diagram of another illustrative method 900 for operating an exit sign (e.g., exit sign 100 of FIG. 1, FIG. 3 of FIG. 3, FIG. 4 of FIG. 4, 502₁, . . . , or 502_{N} of FIG. 5). Method 900 begins with 902 and continues with 904 where the exit sign is used to denote a physical location of a closest exit of a building. Next in 906, electronic circuitry of the exit sign is activated (e.g., by turning on or otherwise by supplying power to the exit sign). When activated, the exit sign may perform a self-test as shown by 908. Results of the self-test can be reported from the exit sign to a remote device (e.g., computing device 524 of FIG. 5).

In 910, the exit sign obtains sensor data generated by sensor(s) internal to or external from the exit sign. The sensor data can specify a condition or characteristic of equipment, an individual or a surrounding environment. The sensor(s) can include, but are not limited to, a camera, a scent detection sensor, a temperature sensor, a humidity sensor, a sound detection sensor, a light detection sensor, a proximity sensor, a motion detection sensor, a communication receiver, a LiDAR system, or a radar system. The sensor data is used in 912 to facilitate (i) remote management of an emergency system for a building, (ii) locating and/or tracking of an individual or asset in the building, and/or (iii) management of an incident event by an organization (e.g., by a public safety and security organization as personal are handling an incident event such as a fire).

In 914, the sensor data is processed by the exit sign and/or the remote device. The sensor data can be processed to determine whether AC power is being supplied to the exit sign and/or to determine whether an amount of light is less than a certain value. As shown by 918, a secondary power source (e.g., power source 508 of FIG. 5) and flood light(s) of the exit sign are activated when a determination is made that AC power is not being supplied to the exit sign [916:NO] or when a determination is made that the amount of light in the surrounding environment is less than a certain amount [918:YES]. Otherwise, method 900 continues to 922.

In 922, the sensor data is processed to determine whether an anomaly exists in the condition or characteristic of the equipment, individual and/or surrounding environment. If so [922:YES], then the exit sign takes an action as shown by 924. If not, then 926 is performed where method 900 ends or other operations are performed (e.g., return to 908 or 910).

In some scenarios, the anomaly is detected when an average temperature of the surrounding environment exceeds a threshold value, when an average humidity in the surrounding environment falls below a threshold value, when an amount of light in the surrounding environment falls below a threshold value during a particular time of day, when a level of smoke in the surrounding environment exceeds a threshold value, when a particular scent exists in the surrounding environment, when a particular sound was made in the surrounding environment, when a total number of people in the surrounding area exceeds a threshold value, when an individual's movement or motion matches by a certain degree a learned pattern for detecting a health issue, or when an amount of time since the individual's last movement exceeds a given amount of time. The action comprises: generating and communicating an alert from the exit sign; and/or generating and submitting a work order.

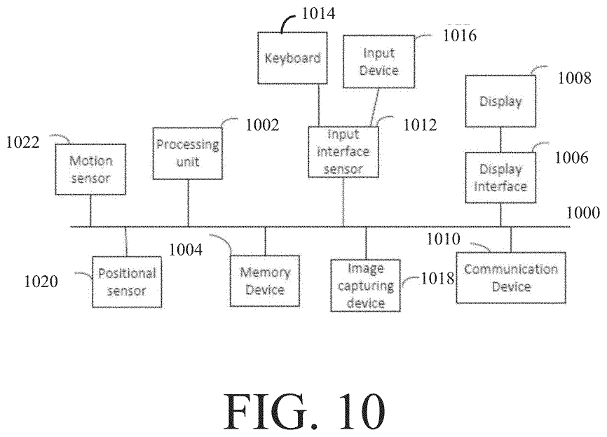

FIG. 10 depicts a block diagram of hardware components that may be used to contain or implement program instructions to execute the functions described above, such as components of a cloud-based server, a client electronic device, a virtual machine, or a container. A bus 1000 serves as an information highway interconnecting the other illustrated components of the hardware. The bus may be a physical connection between elements of the system, or a wired or wireless communication system via which various elements of the system share data. Processor 1002 is a processing device for performing calculations and logic operations required to execute a program. Processor 1002, alone or in conjunction with one or more of the other elements disclosed in FIG. 10 is an example of a processing device, computing device or processor as such terms are used within this disclosure. The processing device may be a physical processing device, a virtual device contained within another processing device, or a container included within a processing device.

A memory device 1004 is a hardware element or segment of a hardware element on which programming instructions, data, or both may be stored. ROM and RAM constitute examples of memory devices, along with cloud storage services.

A display interface 1006 may permit information to be displayed on the display 1008 in visual, graphic or alphanumeric format. The display interface 1006 and display 1008 also may include an audio interface and speaker, or the system may include a separate audio interface and audio output such as a speaker, headphone jack, or antenna for communication with a headset, earbud(s) or other audio devices. Communication with external devices, such as a printing device, may occur using various communication devices 1010, such as a communication port or antenna. A communication device 1010 may be communicatively connected to a communication network, such as the Internet or an intranet.

The hardware may also include a user input interface sensor 1012 which allows for receipt of data from input devices such as a keyboard or keypad 1014, or other input device 1016 such as a mouse, a touch pad, a touch screen, a remote control, a pointing device, a video input device and/or a microphone. Data also may be received from an image capturing device 1018 such as a digital camera or video camera. A positional sensor 1020 and/or motion sensor 1022 may be included to detect position and movement of the device. Examples of motion sensors 1022 include gyroscopes or accelerometers. Examples of positional sensors 1020 include a Global Positioning System (GPS) sensor device that receives positional data from an external GPS network, a triangulation location device that can be used inside buildings, a beacon device, and/or an RFID device.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for operating an exit sign, comprising:
using the exit sign to denote a physical location of a closest exit of a building;
obtaining, by the exit sign, sensor data generated by at least one sensor internal to or external from the exit sign, the sensor data specifying a condition or characteristic of equipment, an individual or a surrounding environment; and
using the sensor data to facilitate at least one of (i) remote management of an emergency system for a building, (ii) locating of an individual or asset in the building, and (iii) management of an incident event by an organization.

2. The method according to claim 1, wherein the at least one sensor comprises a camera, a scent detection sensor, a temperature sensor, a humidity sensor, a sound detection sensor, a light detection sensor, a proximity sensor, a motion detection sensor, a communication receiver, a LiDAR system, or a radar system.

3. The method according to claim 1, further comprising performing operations by the exit sign to detect when AC power is no longer being supplied by an AC power source, and activating at least one flood light of the exit sign to illuminate the surrounding environment in response to a detection that the AC power is no longer being supplied by the AC power source.

4. The method according to claim 1, further comprising performing operations by the exit sign to activate at least one flood light thereof in response to an amount of light in the surrounding environment falling below a certain value.

5. The method according to claim 1, wherein the sensor data is further used to facilitate tracking of movement of the individual or asset in the building.

6. The method according to claim 1, further comprising performing a self-test by the exit sign and reporting results of the self-test to a remote device.

7. The method according to claim 1, further comprising processing the sensor data to detect an anomaly in the condition or characteristic of equipment, an individual or the surrounding environment.

8. The method according to claim 7, wherein the anomaly is detected when an average temperature of the surrounding environment exceeds a threshold value, when an average humidity in the surrounding environment falls below a threshold value, when an amount of light in the surrounding environment falls below a threshold value during a particular time of day, when a level of smoke in the surrounding environment exceeds a threshold value, when a particular scent exists in the surrounding environment, when a particular sound was made in the surrounding environment, when a total number of people in the surrounding area exceeds a threshold value, when an individual's movement or motion matches by a certain degree a learned pattern for detecting a health issue, or when an amount of time since the individual's last movement exceeds a given amount of time.

9. The method according to claim 7, further comprising generating and communicating an alert from the exit sign when the anomaly is detected.

10. The method according to claim 7, further comprising performing operations by the exit sign to generate and submit a work order responsive to a detection of damage to the exit sign based on the sensor data.

11. An exit sign, comprising:
a canopy portion housing a circuit;
a sign portion coupled to the canopy portion and comprising an indicator to denote a physical location of a closest exit of a building;
wherein the circuit comprises a processor and a non-transitory computer-readable storage medium comprising programming instructions that are configured to cause the processor to implement a method for operating the exit sign, wherein the programming instructions comprise instructions to:
obtain sensor data generated by at least one sensor internal to or external from the exit sign, the sensor data specifying a condition or characteristic of equipment, an individual or a surrounding environment; and
use the sensor data to facilitate at least one of (i) remote management of an emergency system for a building, (ii) locating of an individual or asset in the building, and (iii) management of an incident event by an organization.

12. The exit sign according to claim 11, wherein the at least one sensor comprises a camera, a scent detection sensor, a temperature sensor, a humidity sensor, a sound detection sensor, a light detection sensor, a proximity sensor, a motion detection sensor, a communication receiver, a LiDAR system, or a radar system.

13. The exit sign according to claim 11, wherein the programming instructions comprise instructions to detect when AC power is no longer being supplied by an AC power source, and activating at least one flood light of the exit sign to illuminate the surrounding environment in response to a detection that the AC power is no longer being supplied by the AC power source.

14. The exit sign according to claim 11, wherein the programming instructions comprise instructions to activate at least one flood light thereof in response to an amount of light in the surrounding environment falling below a certain value.

15. The exit sign according to claim 11, wherein the sensor data is further used to facilitate tracking of movement of the individual or asset in the building.

16. The exit sign according to claim 11, wherein the programming instructions comprise instructions to causing the exit sign to perform a self-test and report results of the self-test to a remote device.

17. The exit sign according to claim 11, wherein the programming instructions comprise instructions to process the sensor data to detect an anomaly in the condition or characteristic of equipment, an individual or the surrounding environment.

18. The exit sign according to claim 17, wherein the anomaly is detected when an average temperature of the surrounding environment exceeds a threshold value, when an average humidity in the surrounding environment falls below a threshold value, when an amount of light in the surrounding environment falls below a threshold value during a particular time of day, when a level of smoke in the surrounding environment exceeds a threshold value, when a particular scent exists in the surrounding environment, when a particular sound was made in the surrounding environment, when a total number of people in the surrounding area exceeds a threshold value, when an individual's movement or motion matches by a certain degree a learned pattern for detecting a health issue, or when an amount of time since the individual's last movement exceeds a given amount of time.

19. The exit sign according to claim 17, wherein the programming instructions comprise instructions to generate and communicate an alert from the exit sign when the anomaly is detected.

20. The exit sign according to claim 17, wherein the programming instructions comprise instructions to generate and submit a work order responsive to a detection of damage to the exit sign based on the sensor data.
